(19) United States
(12) Patent Application Publication
(10) Pub. No.: US 2014/0006068 A1
(43) Pub. Date: Jan. 2, 2014

(54) System for Executing Travel Related Transactions

(71) Applicant: Mark C. Dawkins, Athens, GA (US)

(72) Inventor: Mark C. Dawkins, Athens, GA (US)

(21) Appl. No.: 13/537,289

(22) Filed: Jun. 29, 2012

(51) Int. Cl. G06Q 10/02

(52) U.S. Cl. 705/5

(57) ABSTRACT

regarding acceptable parameters for the travel-related object, which includes a desired maximum price. The system automatically and periodically searches global computer network sites of travel service providers and when a site offers a travel-related object meeting the user's parameters at less than or equal to the desired maximum price, the system automatically purchases the travel-related object on behalf of the user.

### BACKGROUND OF THE INVENTION

1. Field of the Invention

The present invention relates to electronic contracting systems and, more specifically, to an electronic contracting system employed in the travel industry.

2. Description of the Related Art

Travel-related objects are regularly purchased electronically, such as via the global computer network. Certain systems have “name your own price” sites, wherein a user enters desired parameters for such objects as airline tickets, hotel stays and car rentals and a price that the user is willing to pay. If a supplier of such a service is willing to accept the offered price, then the system will make a purchase of the object on behalf of the user using the user's pre-entered credit card information.

Other sites allow a user to enter information about what the user wants in a travel-related object, such as an airline ticket to a certain destination on a certain date. The site will then display the current fare for the object of the user's search. However, travel fares often change quite quickly and sometimes special fares are available for only a limited amount of time, such as just a few hours. Users of such sites, in order to get a desired deal, often log onto the sites several times per day in hopes of accessing the site during the time a special fare is offered. This can waste valuable time on the part of the user and there is still a probability that the user will miss out on the special fare.

Some users also are interested in researching several different travel options at the same time. For example, a user might want to go on a ski vacation, but may be willing to go to one of several different ski destinations (e.g., Whistler, Lake Tahoe, Sun Valley, Kitzbuhel, etc.). In such a case, the user might be willing to pay more for tickets to certain locations than for tickets to other locations. However, following the current ticket prices of several different options can be extremely time consuming.

Therefore, there is a need for a system that determines a current price for a travel-related object and that automatically purchases the travel-related object on behalf of a user when the current price is not greater than a predetermined maximum desired price.

### SUMMARY OF THE INVENTION

The disadvantages of the prior art are overcome by the present invention which, in one aspect, is a method, operable on a central server computer that is coupled to a global computer network, for executing travel transactions, in which a set of parameters corresponding to a travel-related object is received at the central server computer from a remote computer via the global computer network. The set of parameters includes a user identification, a payment amount and user account information about an account at a financial institution, the user account information including an account number and an authorization to transfer the payment amount from the user account to a selected entity when at least a selected subset of the parameters are matched, the selected subset of parameters including a desired maximum price for the travel-related object. The set of parameters is stored in a computer-readable memory accessible by the central server. Automatically and periodically, the central server is caused to access at least one remote site presented on behalf of a travel organization via the global computer network and to enter into the remote site information from the set of parameters relating to the travel-related object. An indication of a price currently being charged for the travel-related object matching the selected subset of the parameters is received at the central server from the remote site. The central server determines when the price is not greater than the desired maximum price. When the travel-related object is being offered by the travel organization at not greater than the desired maximum price, the travel-related object is then automatically purchased from the travel organization in the user's name via the global computer network. An electronic funds transfer request is transmitted to the financial institution in an amount of the desired maximum price, thereby causing the financial institution to transfer the amount to the selected entity. An electronic notification of the purchase is transmitted to the remote computer via the global computer network upon purchasing the travel-related object.

In another aspect, the invention is an airline ticket buying method, operable on a central server computer that is coupled to a global computer network, in which an indication of a set of parameters entered by a user, including: a desired destination, a desired travel date and a desired payment amount to be paid for an airline ticket for travel to the destination on the desired travel date is received at the central server computer from a remote computer. User account information to an account at a financial institution and an authorization to transfer the payment amount from the user account is received by the central server from the remote computer. The set of parameters and the account information are stored in a computer-readable memory that is accessible by the central server. The central server periodically accesses at least one remote global computer network site presented on behalf of a travel organization that sells airline tickets to determine when the ticket to the destination on the desired travel date is being offered by the travel organization for no more than the desired payment amount. When the ticket to the destination on the desired travel date is being offered by the travel organization for no more than the desired payment amount, then the ticket is automatically purchased from the travel organization by transmitting to the travel organization from the central server, via the global computer network, an electronic payment for the ticket, thereby executing a binding transaction. The user account information and authorization are transferred from the central server to the financial institution and an electronic funds transfer to a selected entity in an amount corresponding to the desired payment amount is requested by the central server. Upon purchasing the ticket, the central server transmits an electronic notification of the purchase to the remote computer via the global computer network.

In yet another aspect, the invention is a central server that is in data communication with at least one remote computer, at least one travel organization remote site and at least one financial institution via a global computer network. The central server includes a processor, a tangible computer-readable memory in data communication with the processor and a program that is stored on the computer-readable memory. The program is configured to instruct the processor to execute a set of instructions, wherein the central server receives, from the remote computer via the global computer network, a set of parameters corresponding to a travel-related object, including a user identification, a payment amount and user account information about an account at a financial institution. The user account information includes an account number and an authorization to transfer the payment amount from the user account to a selected entity when at least a selected subset of the parameters is matched. The selected subset of parameters includes a desired maximum price for the travel-related object. The set of parameters are stored in the computer-readable memory. The travel organization accesses the remote site periodically and enters into the remote site information from the set of parameters relating to the travel-related object. The central server receives from the remote site an indication of a price currently being charged for the travel-related object matching the selected subset of the parameters. When the price is not greater than the desired maximum price then the central server transmits to the remote site a request to automatically purchase the travel-related object and a payment for the travel-related object. An electronic funds transfer request is transmitted from the central server to the financial institution in an amount of the desired maximum price, thereby causing the financial institution to transfer the amount to the selected entity. An electronic notification of the purchase is transmitted to the remote computer.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of one embodiment of a system for executing travel-related transactions.

FIG. 2A is a schematic diagram of one embodiment of a data entry screen.

FIG. 2B is a schematic diagram of one embodiment of a data entry screen for a situation wherein a user finds several different travel options acceptable.

FIG. 2C is a schematic diagram of one embodiment of a data entry screen for a situation in which tickets for several passengers are being purchased.

FIG. 3 is a flow chart demonstrating one embodiment of a method of automatically purchasing travel objects.

FIG. 4 is a schematic diagram of one embodiment of a travel object purchase notification screen sent to a user.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

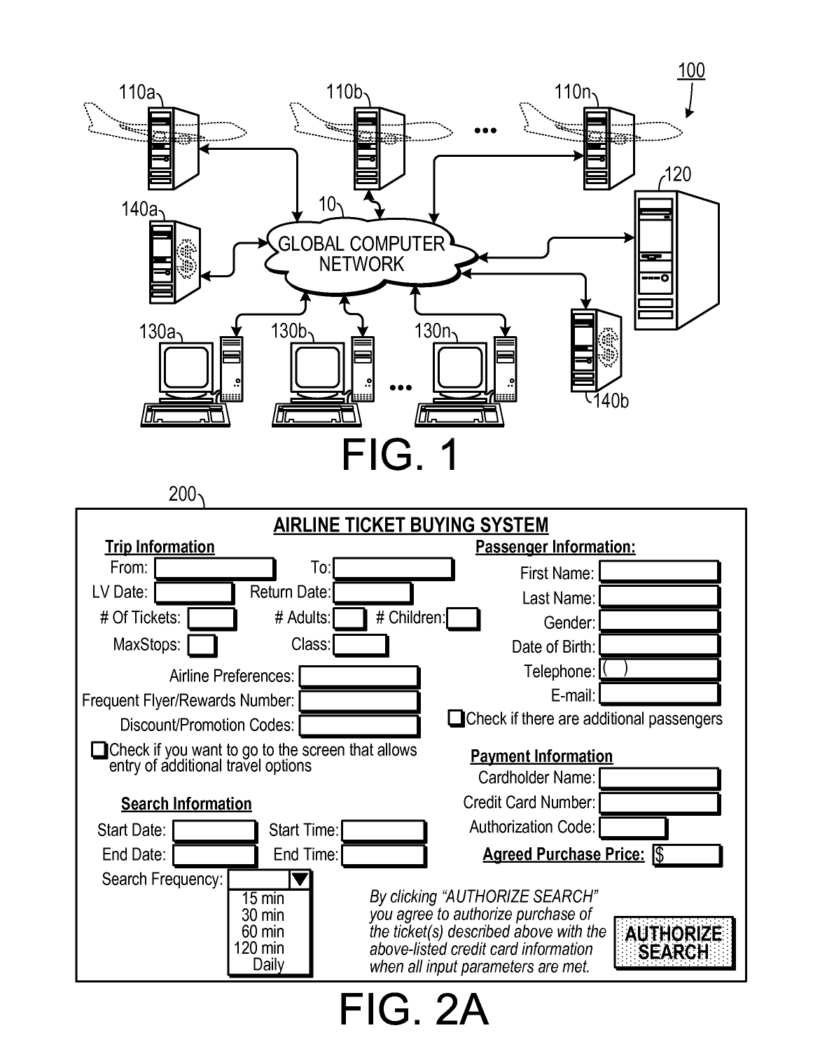

As shown in FIG. 1, one embodiment of a system for executing travel-related transactions 100 employs a central server 120 that includes a processor and a tangible computer readable memory, such as a disk drive, a flash drive, and the like. The central server 120 is in communication with a global computer network 10, which is in communication with a plurality of remote travel-related sites 110a-110n and a plurality of user-operated remote computers 130a-130n. A user's financial institution 140a can be accessed by the central server 120 via the global computer network 10. The user's financial institution 140a could include, e.g., a credit card company, a bank, an on-line payment processing company, or any institution capable of transferring funds as a result of a computer-initiated request. A system financial institution 140b can also be accessed by the central server 120 for the purpose of transferring funds from a user's financial institution 140a into a system account, or for transferring funds from a system account to an account associated with one of the remote travel-related sites 110a-110n in payment for a travel-related object.

An alternate embodiment can employ a fee-based option where the travel object is automatically purchased at the quoted price when the quoted price is less than the desired maximum price. In this scenario, an electronic funds transfer request is transmitted to the financial institution in an amount of the quoted price plus a predetermined fee charged by the entity administering the system. This causes the financial institution to transfer the combined amount to the selected entity.

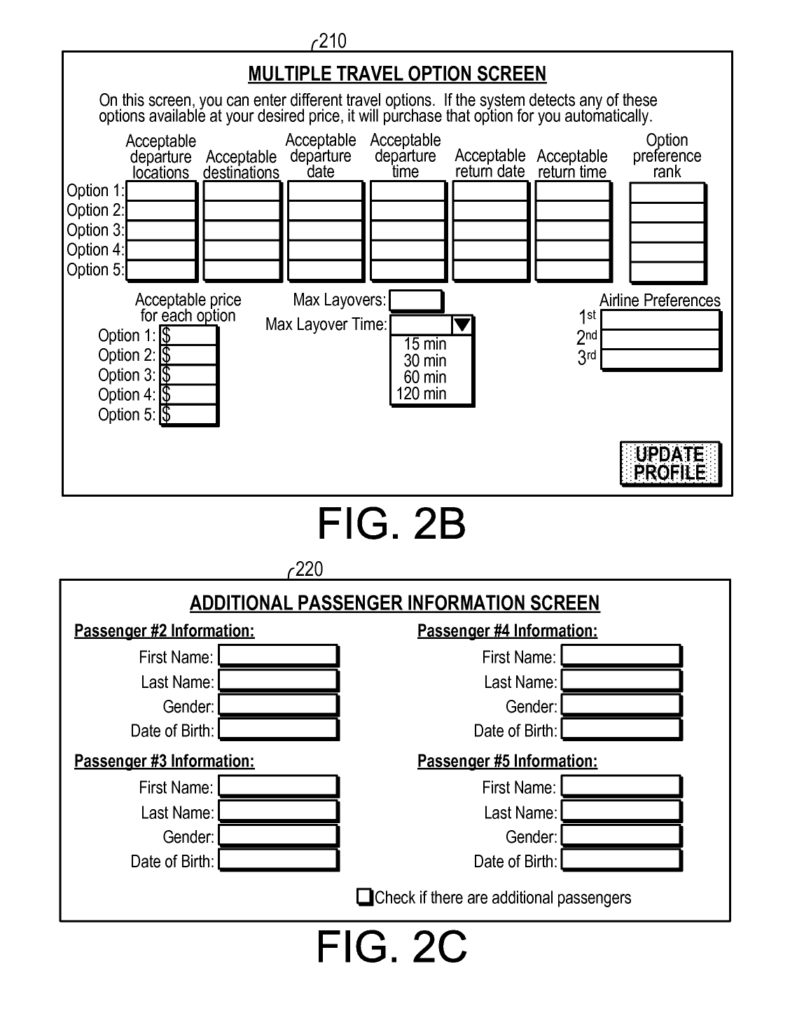

In one embodiment, a user accesses a site (such as a Web site) presented by the server 120 from a remote computer (e.g., computer 130a) and includes a data input screen. (It should be readily appreciated that the invention could also be embodied in a variety of devices and applications, including applications that run on smart phones, portable media players, desktop computers, laptop computers, tablet computers and any other device capable of communicating with a central server.) Typically, the user would enter login information including a password (or other identity verifying information) and the server 120 would include a security mechanism that would ensure information entered by the user remains secure. One representative example of a possible data input screen 200 is shown in FIG. 2A. The data input screen 200 allows the user to input information about a travel-related object that the user desires to purchase. The travel-related object could be one or more of: an airline ticket, a cruise ticket, a hotel room reservation, a rental car reservation, a theme park ticket, a lift ticket, an attraction ticket, a tour ticket, a vacation home rental reservation or any other type of object that a user might want to purchase as part of a plan. Such a plan could include a travel plan, a business plan, a leisure plan or an entertainment plan.

In the example shown in FIG. 2A, the data input screen is directed to the purchase of airline tickets and the information input might include such parameters as: travel departure location, departure date, travel destination, return date, number of tickets required, number of adults traveling, number of children traveling, the maximum number of stopovers that the user is willing to accept, the user's preferred travel class, the user's preferred airline, the user's frequent flyer/rewards number, any applicable discount or promotion codes, information about the passenger (e.g., first name, last name, gender and birthdate), payment information (including the cardholder's name and address, the cardholder's credit card number and the credit card authorization code), the time frequency of searches, the date and time that the user wants the system to start searching for desired deals, and the date and time that the user wants the system to cease searching for deals. Data input screen 200 also includes a purchase price at which the user agrees to be bound. Once the user has entered the necessary data, the user can click on an “Authorize Search” button, which causes the server 120 to conduct a search for the travel-related object that meets the parameters input by the user. In this screen, the user can specify the frequency at which the system will check travel sites (e.g., every 15 minutes, every 30 minutes, etc., or a user specific amount of time) if the user desires a search frequency other than a default frequency (e.g., every 15 minutes). This screen may also include a check box that directs the user to another screen 220, shown in FIG. 2C. Screen 220 allows entry of additional passenger information when checked.

The user might want to authorize a search for several different options for a desired travel-related object. For example, the user might desire to take a beach vacation in which acceptable options would include Destin, Tybee Island, Charleston and South Beach. If so, the screen 200 can include a check box that, if checked, will cause, as shown in FIG. 2B, a multiple option data input screen 210 to be displayed. This screen 210 allows the user to create several different acceptable options for travel, including different prices that the user is willing to pay for each option. This screen might also include a listing of several different travel-related object sources (e.g., different airlines) that the user is willing to use. This screen 210 can also include a option preference rank that allows the user to rank the different options so that if two options become available simultaneously, the system will select the highest ranking option, so that the buyer will be charged only for the preferred option. As shown in FIG. 2C, a screen 220 would allow for the entry of passenger information when tickets for more than one passenger are being purchased at the same time. As will be readily recognized by those of skill in this art, the screens shown in FIGS. 2A-2C are only representative of one embodiment and that many other data input screens and option combinations could be employed within the scope of the present invention.

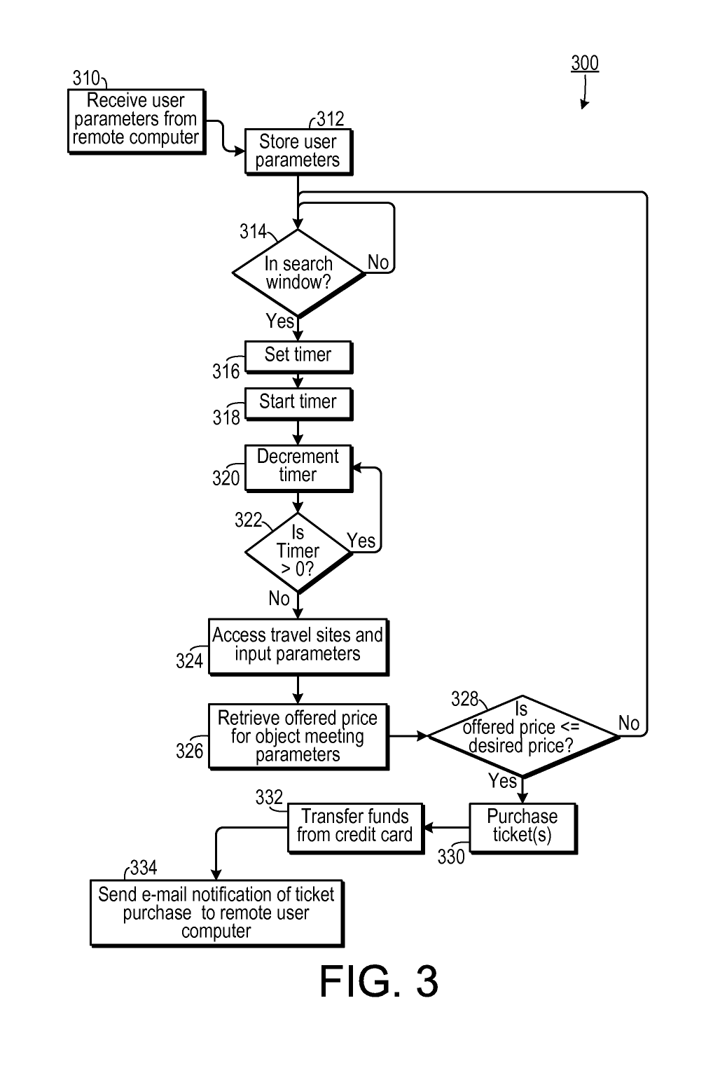

As shown in FIG. 3, one method employed by a travel-related object buying service operates the central server to run a program 300 that causes the central server initially to receive 310 from the user (such as through the screens shown in FIGS. 2A-2C) the user's travel parameters. The server stores 312 the parameters in its memory and then determines if it is currently within a search window 314 (i.e., it compares the current date and time to the search beginning dates and times and the search ending dates and times to determine if the current date and time is within those parameters). If it is within the search window, then the system sets a timer 316 for a predetermined amount of time (e.g., the system might be programmed to conduct a search every five minutes, in which case the timer would be set for a number of counts corresponding to five minutes) and then decrements the time 320 by a predefined number of counts. If the timer has not yet reached zero 322 the system decrements the timer again. Once the timer reaches zero, the system accesses one or more travel sites 324 and inputs the parameters related to the user's purchase criteria (e.g., departure location, destination, travel dates, etc.). This accessing of travel-sites is conducted automatically by the central server and does not require user input for each search to be conducted. The system then retrieves 326 the price offered by at least one of the travel sites and compares it to the user's desired price 328. If none of the travel sites offers the desired travel-related object for less than or equal to the user's desired price, the system repeats the process. However, if one of the travel sites offers the desired travel-related object at less than or equal to the user's desired price, then the system will automatically purchase the travel-related object 330 from the travel site and will also authorize a transfer of funds 332 from the user's financial institution to cover the purchase and any profit being made by the operator of the system. The system will cause such funds to be transferred to the buying service's financial institution. An electronic notification (such as an e-mail notification or a screen display, or both) is then sent to the user 334 indicating that the travel-related object has been purchased.

In one option, the travel-related object is automatically purchased at the desired maximum price and the service can split the savings with the user (e.g., 50/50) in the form of a voucher for future use of the service. As will be readily apparent, the system can profit in many other ways. For example, the service can receive commissions from travel service providers and can also receive payment for the display advertising. In one option, a travel agency could use the system for the benefit of its customers.

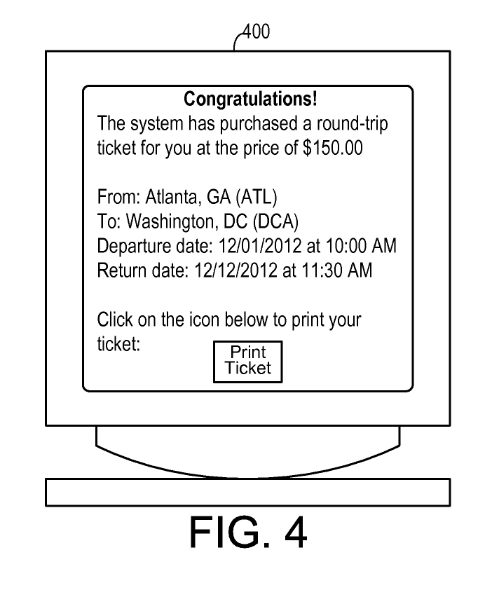

Such a notification 400 could appear similar to the screen shown in FIG. 4. It could include a button which, when clicked, would cause a ticket, a boarding pass, a reservation confirmation, a voucher or other document confirming the purchase to be printed. Many other means of transferring a travel-related object to the user could also be employed, including printing a ticket and sending the printed ticket to the user or transmitting an electronic ticket to the user.

While the example disclosed relates to the purchase of airline tickets, it should be readily recognized that the present system could be applied also to any type of travel-related objects, including: hotel reservations, cruise tickets, car rentals, theme park tickets, cruises, lift tickets, attraction tickets, tour tickets, vacation home rental reservations and the like. The system can offer to assist the user in searching for travel-related objects other than the user's primary travel object. For example, when a user searches for an airline ticket, the system can also offer to use a similar search process for renting a hotel room and a rental car.

In one embodiment, the buying service makes its profit as the difference between the user's desired maximum price minus the price currently being charged for the travel-related object, which is placed into an account belonging to the service.

The system also allows consumers to enter orders that may change over time. For example, the user might be able to enter an initial order to have the website search from February-May for a $250 airline ticket for travel in December 2012, and at the time the initial order is entered the user may specify a change in price to $300 from June-July, and $400 from August-September.

Another feature of one embodiment is that the system may have the ability to enter multiple orders where the execution of one order cancels the remaining orders. The system does not require the user to search for acceptable prices constantly, nor does it require the user to bid repeatedly in an attempt to get acceptable prices. Once the user enters a fixed-price and acceptable travel parameters, the system constantly searches vendor sites and, once found, one embodiment can be configured to either 1) automatically purchase the fixed-price travel object, or 2) text or e-mail the user for permission to try to purchase the fixed-price travel.

The system can make money in two ways: 1) when it finds the travel item at a price lower than the entered fixed-price, it books the travel at the fixed-price and keeps the difference (if any) as revenue, or 2) when it finds the travel item at a price lower than the entered fixed-price, it books the travel at the fixed-price and splits the difference with the client in some proportion (e.g., 50/50) with the system keeping its share as revenue. The system can also receive commissions paid by the travel providers. The system can also employ a fee-based option where the travel object is automatically purchased at the quoted price when the quoted price is less than the desired maximum price and an electronic funds transfer request is transmitted to the financial institution in an amount of the quoted price plus a predetermined fee charged by the entity administering the system. This causes the financial institution to transfer the combined amount to the selected entity.

In various embodiments, the system can receive many different parameters. The following are partial and non-exclusive representative lists of such parameters.

Airline Ticket Parameters:
DEPARTURE LOCATION:
DESTINATION:
LEAVE DATE:
RETURN DATE:
ACCEPTABLE ALTERNATE DATES:
OUTBOUND FLIGHT WINDOW: (1 HR, 2 HR, 3 HR, 4 HR, ETC. UP TO ANYTIME)
RETURN FLIGHT WINDOW: (1 HR, 2 HR, 3 HR, 4 HR, ETC. UP TO ANYTIME)
SEARCH START DATE: (SPECIFY OR NOW)
SEARCH START TIME: (SPECIFY OR NOW)
SEARCH END DATE: (SPECIFY OR GTC)
SEARCH END TIME: (SPECIFY OR GTC)
# OF TICKETS:
FULL ORDERS ONLY: (YES OR NO)
IF PARTIAL ORDERS OK, # TICKETS REQUIRED TO AUTHORIZE
PURCHASE:
TICKET CLASS: (FIRST CLASS OR ECONOMY)
NONSTOP: (YES OR NO)
STOPS: (0, 1, 2, 3, ETC.)
MAX LAYOVER PER STOP: (1 HR, 2 HR, 3 R, ETC.)
AIRLINE PREFERENCES: (DELTA, UNITED, AMERICAN, FRONTIER, ETC., ANY)
SEAT CHOICE: (AISLE, MIDDLE, WINDOW, ANY)
SEAT LOCATION PREFERENCE: (FRONT HALF, BACK HALF, ANY)
TYPE OF PLANE: (JET, PROP, ANY)
# OF ADULTS, SENIORS, CHILDREN (AGE OF CHILDREN):
PASSENGER DATA: (NAME, DATE OF BIRTH, GENDER, ETC.)
FREQUENT FLYER/REWARDS INFORMATION:
DISCOUNT/PROMOTION CODES:

Cruise Ticket Parameters:
CRUISE DESTINATION:
CRUISE LENGTH:
DEPARTURE MONTH:
DEPARTURE DAY:
ACCEPTABLE ALTERNATE DATES:
US RESIDENT: (YES OR NO)
ANYONE OVER 55: (YES OR NO)
ANYONE CRUISED BEFORE: (YES OR NO)
ADDITIONAL OPTIONS:
CRUISE LINE:
CRUISE SHIP:
CRUISE DEPARTURE PORT:
STATEROOM: (INTERIOR, OCEANVIEW, BALCONY, SUITE)
SEARCH START DATE: (SPECIFY OR NOW)
SEARCH START TIME: (SPECIFY OR NOW)
SEARCH END DATE: (SPECIFY OR GTC)
SEARCH END TIME: (SPECIFY OR GTC)
# OF TICKETS:
FULL ORDERS ONLY: (YES OR NO)
IF PARTIAL ORDERS OK, # TICKETS REQUIRED TO AUTHORIZE
PURCHASE:
# OF ADULTS, SENIORS, CHILDREN (AGE OF CHILDREN):
PASSENGER DATA: (NAME, DATE OF BIRTH, GENDER, ETC.)
FREQUENT FLYER/REWARDS INFORMATION:
DISCOUNT/PROMOTION CODES:
Car Rental Parameters:
RENTAL CITY:
PICK-UP LOCATION:
DROP-OFF LOCATION
PICK-UP DATE:
PICK-UP TIME:
DROP-OFF DATE:
DROP-OFF TIME:
ACCEPTABLE ALTERNATE DATES:
TYPE OF CAR: (ECONOMY, COMPACT, MIDSIZE, STANDARD, FULL SIZE, PREMIUM, LUXURY, CONVERTIBLE, VAN, SUV, SPECIALTY, ETC., ANY)
CAR RENTAL COMPANY: (ADVANTAGE, AVIS, BUDGET, DOLLAR, HERTZ, THRIFTY, ETC.)
DISCOUNT CODES:
AIR CONDITIONING: (YES, NO, NO PREFERENCE)
TRANSMISSION: (AUTOMATIC, MANUAL, NO PREFERENCE)
FREQUENT FLYER/REWARDS INFORMATION:
DISCOUNT/PROMOTION CODES:

Hotel Reservation Parameters:
HOTEL CITY:
HOTEL LOCATION: (CITY, POINT OF INTEREST, REGION, AIRPORT, ZIP CODE, ETC.)
CHECK-IN DATE:
CHECK-OUT DATE:
ACCEPTABLE ALTERNATE DATES:
NUMBER OF ROOMS: (1, 2, 3, ETC.)
ROOM 1: # OF ADULTS, # OF CHILDREN, AGE OF CHILDREN
ROOM 2: # OF ADULTS, # OF CHILDREN, AGE OF CHILDREN
STAR RATING: (2+, 3+, 4+, 5, ANY)
HOTEL CHAIN: (ANY, OR SEE LIST ON ORBITZ)
HOTEL NAME:
FREQUENT FLYER/REWARDS INFORMATION:
DISCOUNT/PROMOTION CODES:

The system can allow the user to purchase the components of an entire event or combinations of events. For example, a user might want to go on a tour of Europe. While in one embodiment the user might be able to purchase a tour package that meets the user's criteria, or the user might want to create a custom tour package. In this case, the user could input selected cities (e.g., for an Italian vacation the user might select the following: Rome, Naples, Florence, Venice, Padua and Milan, or the user might input several options for combinations of cities) for selected dates. The user could select modes of transportation (e.g., fly into and out of Rome and then take a train between all of the cities in the tour, fly between each city, or use a rental car between cities) and could specify hotel preferences and even attractions that the user wishes to visit in each city. The user could specify a total desired price for the entire tour or could specify desired prices for the individual components of the tour. As a result, the system can purchase all of the necessary components of the tour, including: airline tickets, train tickets, hotel reservations, attraction tickets and even prepaid meal plans.

In one embodiment, the system can be configured to prevent people from entering frivolous orders (e.g., entering maximum price for a plane ticket that is well below a previously-determined minimum) by rejecting parameters (such as prices) that are outside of a predetermined range.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method, operable on a central server computer that is coupled to a global computer network, for executing travel transactions, comprising the steps of:
(a) receiving, at the central server computer from a remote computer via the global computer network, a set of parameters corresponding to a travel-related object, including a user identification, a payment amount and user account information about an account at a financial institution, the user account information including an account number and an authorization to transfer the payment amount from the user account to a selected entity when at least a selected subset of the parameters are matched, the selected subset of parameters including a desired maximum price for the travel-related object;
(b) storing the set of parameters in a computer-readable memory accessible by the central server;
(c) automatically and periodically causing the central server to access at least one remote site presented on behalf of a travel organization via the global computer network and entering into the remote site information from the set of parameters relating to the travel-related object;
(d) receiving at the central server from the remote site an indication of a price currently being charged for the travel-related object matching the selected subset of the parameters;
(e) determining, by the central server, when the price is not greater than the desired maximum price;
(f) when the travel-related object is being offered by the travel organization at not greater than the desired maximum price, then automatically purchasing the travel-related object from the travel organization in the user's name via the global computer network;
(g) transmitting an electronic funds transfer request to the financial institution in an amount of the desired maximum price, thereby causing the financial institution to transfer the amount to the selected entity; and
(h) upon purchasing the travel-related object, transmitting an electronic notification of the purchase to the remote computer via the global computer network.

2. The method of claim 1, wherein the travel-related object comprises an object selected from a group consisting of: an airline ticket, a cruise ticket, a hotel room reservation, a rental car reservation, a theme park ticket, a lift ticket, an attraction ticket, a tour ticket, a vacation home rental reservation and combinations thereof.

3. The method of claim 1, wherein the selected entity comprises a ticket buying service that operates the central server.

4. The method of claim 1, further comprising the step of transferring a document confirming purchase of the travel-related object to the remote computer.

5. The method of claim 4, wherein the document comprises a document selected from a list of documents consisting of: a ticket, a reservation, a voucher and combinations thereof.

6. The method of claim 1, wherein the set of parameters includes parameters selected from a list consisting of: acceptable departure locations; acceptable destination locations; leave date; return date; acceptable alternate dates; outbound flight window; return flight window; search start date; search start time; search end date; search end time; number of tickets; full orders only; whether partial orders are acceptable, number of tickets required to authorize purchase; ticket class; number of stops; maximum layovers per stop; airline preferences; seat choice; seat location preference; type of plane; number of adults; number of children; age of children; passenger name; passenger date of birth; passenger gender; passenger telephone number; passenger address; frequent flyer number; and discount/promotion codes.

7. The method of claim 1, wherein the price currently being charged for the travel-related object is less than the desired maximum price and further comprising the step of transferring funds in an amount of the desired maximum price minus the price currently being charged for the travel-related object into an account belonging to the selected entity.

8. An airline ticket buying method, operable on a central server computer that is coupled to a global computer network, comprising the steps of:
(a) receiving at the central server computer from a remote computer an indication of a set of parameters entered by a user, including: a desired destination, a desired travel date and a desired payment amount to be paid for an airline ticket for travel to the destination on the desired travel date;
(b) receiving, by the central server from the remote computer, user account information to an account at a financial institution and an authorization to transfer a payment amount from the user account;
(c) storing the set of parameters and the account information in a computer-readable memory accessible by the central server;
(d) periodically accessing, by the central server, at least one remote global computer network site presented on behalf of a travel organization that sells airline tickets to determine when the ticket to the destination on the desired travel date is being offered by the travel organization for no more than the desired payment amount;
(e) when the ticket to the destination on the desired travel date is being offered by the travel organization for no more than the desired payment amount, then automatically purchasing the ticket from the travel organization by transmitting to the travel organization from the central server, via the global computer network, an electronic payment for the ticket, thereby executing a binding transaction;
(f) transferring the user account information and authorization from the central server to the financial institution and requesting an electronic funds transfer to a selected entity in an amount corresponding to the desired payment amount; and
(g) upon purchasing the ticket, transmitting an electronic notification of the purchase from the central server to the remote computer via the global computer network.

9. The airline ticket buying method of claim 8, wherein the step of receiving a set of parameters includes the step of receiving an identification of more than one acceptable travel destination.

10. The airline ticket buying method of claim 8, wherein the step of receiving a set of parameters includes the step of receiving an identification of more than one acceptable travel date.

11. The airline ticket buying method of claim 8, further comprising the step of transmitting a ticket to the user upon purchasing the ticket.

12. The airline ticket buying method of claim 8, further comprising the step of offering to search for a travel-related object in addition to the ticket for the user.

13. The airline ticket buying method of claim 8, wherein the travel-related object comprises an object selected from a group consisting of: an airline ticket, a cruise ticket, a hotel room reservation, a rental car reservation, a theme park ticket, a lift ticket, an attraction ticket, a tour ticket, a vacation home rental reservation and combinations thereof.

14. The airline ticket buying method of claim 8, wherein the selected entity comprises a ticket buying service that operates the central server.

15. The airline ticket buying method of claim 8, wherein the price currently being charged for the travel-related object that is less than the desired maximum price and further comprising the step of transferring funds in an amount of the desired maximum price minus the price currently being charged for the travel-related object into an account belonging to the selected entity.

16. A central server, in data communication with at least one remote computer, at least one travel organization remote site and at least one financial institution via a global computer network, the central server comprising:
(a) a processor;
(b) a tangible computer-readable memory in data communication with the processor;
(c) a program, stored on the computer-readable memory and configured to instruct the processor to execute a set of instructions, including:
(i) receive, from the remote computer via the global computer network, a set of parameters corresponding to a travel-related object, including a user identification, a payment amount and user account information about an account at a financial institution, the user account information including an account number and an authorization to transfer the payment amount from the user account to a selected entity when at least a selected subset of the parameters are matched, the selected subset of parameters including a desired maximum price for the travel-related object;
(ii) store the set of parameters in the computer-readable memory;
(iii) access the travel organization remote site periodically and enter into the remote site information from the set of parameters relating to the travel-related object;
(iv) receive from the remote site an indication of a price currently being charged for the travel-related object matching the selected subset of the parameters;
(v) when the price is not greater than the desired maximum price then transmit to the remote site a request to purchase the travel-related object and a payment for the travel-related object;
(vi) transmit an electronic funds transfer request to the financial institution in an amount of the desired maximum price, thereby causing the financial institution to transfer the amount to the selected entity; and
(vii) transmit an electronic notification of the purchase to the remote computer.

17. The central server of claim 16, wherein the travel-related object comprises an object selected from a group consisting of: an airline ticket, a cruise ticket, a hotel room reservation, a rental car reservation, a theme park ticket, a lift ticket, an attraction ticket, a tour ticket, a vacation home rental reservation and combinations thereof.

18. The central server of claim 16, wherein the selected entity comprises a ticket buying service that operates the central server.

19. The central server of claim 16, wherein the program further comprises an instruction to transfer a document confirming purchase of the travel-related object to the remote computer.

20. The central server of claim 16, wherein the document comprises a document selected from a list of documents consisting of: a ticket, a reservation, a voucher and combinations thereof.

21. The central server of claim 16, wherein the set of parameters includes parameters selected from a list consisting of: acceptable departure locations; acceptable destination locations; leave date; return date; acceptable alternate dates; outbound flight window; return flight window; search start date; search start time; search end date; search end time; number of tickets; full orders only; whether partial orders are acceptable, number of tickets required to authorize purchase; ticket class; number of stops; maximum layovers per stop; airline preferences; seat choice; seat location preference; type of plane; number of adults; number of children; age of children; passenger name; passenger date of birth; passenger gender; passenger telephone number; passenger address; frequent flyer number; and discount/promotion codes.
